(19) United States
(12) Patent Application Publication
(10) Pub. No.: US 2012/0240783 A1
(43) Pub. Date: Sep. 27, 2012

(54) HOT-BEVERAGE MACHINE WITH A VALVE ARRANGEMENT

(75) Inventors: Josef Daburger, Siegsdorf-Hammer (DE); Wolfgang Georg, Weibhausen (DE); Ulrike Gerl, Traunstein (DE)

(73) Assignee: BSH BOSCH UND SIEMENS HAUSGERÄTE GMBH, Munich (DE)

(21) Appl. No.: 13/513,585

(22) PCT Filed: Dec. 7, 2010
(86) PCT No.: PCT/EP10/69050

§ 371 Date: Jun. 4, 2012

(30) Foreign Application Priority Data
Dec. 29, 2009 (DE) 10 2009 055 384.3

(51) Int. Cl. A47J 31/46; B01D 19/00

(52) U.S. Cl. 99/288; 137/197

(57) ABSTRACT

A hot-beverage machine includes a water-storage tank, a heating device and a brewing chamber, which are connected to one another by a conduit system. A valve arrangement is disposed in a conduit segment of the conduit system and includes a gas-permeable membrane which includes a material made of PTFE and can be coated with a water-repellent coating.

The invention relates to a hot beverage machine for household purposes, having a water storage tank, a heating facility and a brewing chamber, which are connected to one another by a conduit system, and having a valve arrangement in at least one conduit segment of the conduit system. The invention also relates to the use of a valve arrangement in a conduit system of a hot beverage machine between a water storage tank and a brewing chamber as a pressure compensation valve.

DE 10 2007 058 375 A1 describes a hot beverage machine of the type mentioned in the introduction. The valve arrangement here is configured as an automatically switching overpressure or negative pressure valve of a coffee pod or multiple beverage machine, which can also be actuated in a pressure-independent manner. A certain force must be exerted in each instance to open or close such an overpressure or negative-pressure valve, said force being above a certain threshold value. However if the pressure differences are very small, sufficient force is not produced to bring about a corresponding valve switch (closing or opening).

The object of the invention is to allow better pressure compensation.

According to the invention this object is achieved by a hot beverage machine of the type mentioned in the introduction, in which the valve arrangement comprises a gas-permeable membrane. A gas-permeable membrane here is a membrane which, because of its pore size, allows the passage of those gaseous components of air, which make up the majority of its volume. Nitrogen and/or oxygen in particular are therefore allowed to pass through. It is assumed here that the passage of the abovementioned gaseous air components is possible at least in the pressure range that typically occurs in a hot beverage machine. In hot beverage machines in current use, such as coffee machines for example, this pressure range is between 300 mbar (at negative pressure) and 15 bar (at very high overpressure). It is also advantageous if the membrane is also configured to be steam-permeable in the cited pressure conditions, so that steam can also escape.

A valve arrangement generally refers to a single-part or multiple-part arrangement of functional parts including housing parts and/or fastening elements, which interact to perform the function of a valve, specifically the automatic and/or actuator-controlled passage of fluids. A valve arrangement can therefore be made up of a number of components or can be a very simple valve consisting of only one component, for example a hose valve, which overpressure causes to be squashed so that it closes.

Instead of a valve that is actuated mechanically by means of an opening and closing mechanism, the invention therefore makes use of a gas-permeable membrane as a pressure compensation element. This means that pressure compensation between the conduit system and its surroundings can start practically as soon as a pressure difference occurs. Even a small difference in the single-figure mbar region is sufficient to bring about a flow of gas through the membrane. This has the advantage that overpressure or negative pressure in the conduit system can be relieved more quickly and completely than when using a mechanically opening and closing valve.

Also the inventive valve arrangement is much less susceptible to dirt, because it does not require any mechanically moving parts, which could be impaired by dirt. This is a particular risk for mechanical valves in areas of use where the mains water is extremely hard. Deposits on the membrane, which could also impair its effectiveness, can be counteracted by a cleaning operation that is simple to perform on the inner face of the membrane facing the conduit system.

The use of a gas-permeable membrane as an element of the valve arrangement also has the advantage that the valve arrangement can ensure pressure compensation in both flow directions without outside intervention. It acts as a bi-directional valve but without the double risk of dirt as with a mechanical bi-directional valve.

According to a first variant of the invention the valve arrangement is disposed in a conduit segment between water storage tank and heating facility. In this instance it is used primarily for negative pressure compensation. Negative pressures can result from cooling of the conduit system as steam condenses after the end of a brewing process. The resulting negative pressure is therefore relieved upstream of the heating facility, so that water from the water storage tank is not sucked in the direction of the heating facility.

Alternatively or additionally according to a second variant of the invention the valve arrangement is disposed in a conduit segment between heating facility and brewing chamber. Here it is used primarily to compensate for overpressure, which builds up toward the end of a brewing process, when a jet of steam is generated to clean the brewing chamber and the brewing material stored there or a brewing capsule inserted there. The overpressure remaining after the jet of steam can be relieved with the aid of the overpressure valve. Negative pressures resulting from the cooling of the system can therefore be reduced accordingly.

The membrane is essentially water-impermeable in a pressure range normally occurring in the conduit segment—in particular in the pressure range cited above. This prevents moisture, specifically (hot) preparation water for beverages, accidentally escaping from the conduit system. This could cause damage to the hot beverage machine or cause users of the beverage machine to be scalded. The pore size of the membrane is therefore selected so that the water molecules, which are larger than most gas molecules, cannot pass through, at least not in a liquid aggregate state. In contrast the discharge of steam is sometimes desirable—as noted above.

Provision is advantageously made for the membrane to comprise a material made of polytetrafluoroethylene (PTFE). This membrane material, which is marketed by the Gore company under the trade name GORE-TEX®, is widely proven and can be obtained easily and in practically any manufacturing process. It is flexible and can therefore also be configured as a hose for example. In one possible advantageous embodiment of the invention therefore the membrane is integrated as a hose element in the conduit system. This allows it to be integrated in the conduit system in a space-saving manner, also offering a large surface over which the pressure compensation can take place.

In order to allow the fastest and most effective pressure compensation possible, provision can also be made for the membrane to be coated in a water-repellent manner. The water present in the conduit system therefore drips off the membrane so that solids also contained in the water, in particular calcium, cannot easily be deposited on the membrane and block its pores. This effectively reduces the maintenance outlay for the valve arrangement.

This purpose is also served by an advantageous development, in which the membrane is disposed in a removable manner in the valve arrangement. Instead of replacing the entire valve arrangement, it is possible simply to remove the consumable material, i.e. the soiled membrane, and either clean it or replace it. The membrane can be allowed to be removed for example by clamping said membrane in the valve arrangement. This can be done for example with the aid of two clamping parts of a valve housing, which can be connected to one another with a force fit for example by means of a screw or bayonet fastening or by means of a clip. The membrane is then released by opening the fastening. Alternatively or additionally the membrane can also be fastened in the valve arrangement in a detachable or permanent manner by adhesion, so that it can only be removed by pulling out, detaching or cutting out.

Provision can also be made for the valve arrangement to comprise a mechanically opening and closing valve. Such an auxiliary valve can be configured in the manner of the prior art. This allows the valve arrangement to switch to and from at least one flow direction, either as a function of pressure or by external actuation. In some applications, where the supply or removal of air is only desired when the negative pressure or overpressure exceeds a certain threshold value, the auxiliary valve serves to comply with this threshold value.

The invention also encompasses the use of a valve arrangement comprising a gas-permeable membrane in a conduit system of a hot beverage machine between a water storage tank and a brewing chamber as a pressure compensation valve.

The principle of the invention is described in more detail below with reference to a drawing by way of example, in which drawing:

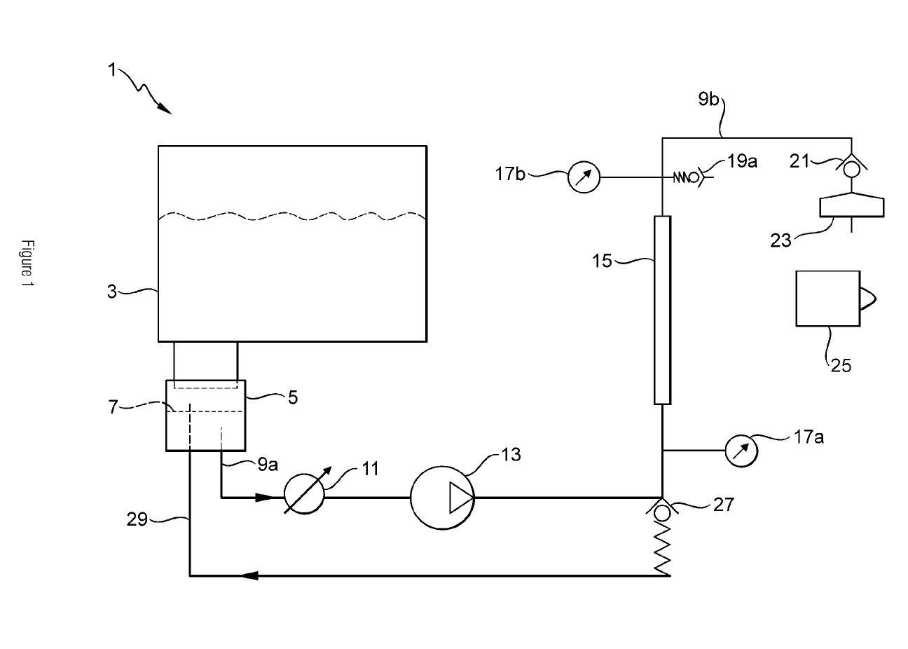

FIG. 1 shows a schematic layout of a first embodiment of an inventive hot beverage machine,

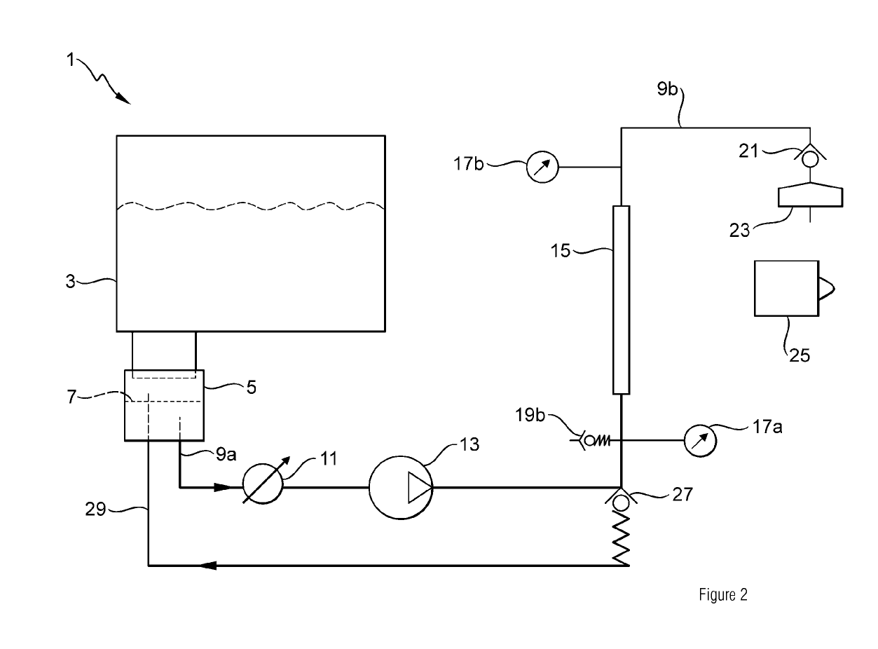

FIG. 2 shows a schematic layout of a second embodiment of an inventive hot beverage machine,

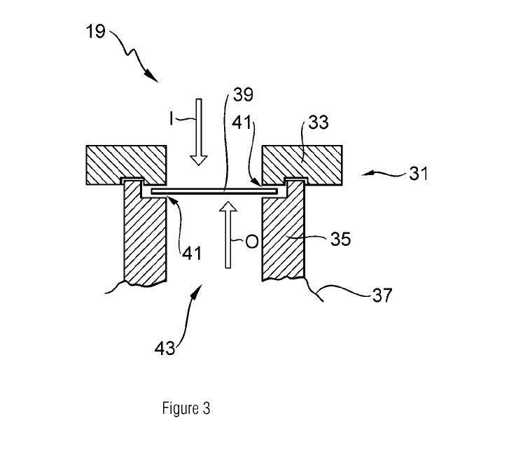

FIG. 3 shows a sectional view of an embodiment of a valve arrangement for use within the scope of the invention.

In principle a hot beverage machine 1, which is configured as a pod or multiple beverage machine according to FIG. 1, comprises a water storage tank 3, which provides fresh water, which reaches a heating facility 15 by way of a first fluid conduit 9a through a throughflow meter 11 and a pump 13. To this end the water storage tank 3 in the present exemplary embodiment is connected by way of a docking valve 5 with a cleaning filter 7 to the first fluid conduit 9a.

The pump 13 is also configured as a non-return valve, so that the fresh water does not return to the water storage tank 13 as a result of the pressure produced when it is heated in the heating facility 15 when the pump 13 is deactivated but is conveyed in the direction of a brewing chamber 23. Disposed between the pump 13 and the heating facility 15 is an overpressure valve 27 that opens as a function of pressure and dissipates any overpressure that may occur upstream of the heating facility 15 by way of a return conduit 29 into the water storage tank 3, avoiding the pump 13. It can also be switched by an actuator, independently of pressure. If there is a defect in the heating facility 15 for example, residual fluid can thus be discharged by way of the return conduit 29 before maintenance work is started. In the illustrated layout however it only serves to relieve overpressure in a pressure-dependent manner, as a result for example of pressure problems in the heating facility 15 due to calcification.

Disposed upstream of the heating facility 15 is a first temperature sensor 17a and disposed downstream of the heating facility 15 in a second fluid conduit 9b is a second temperature sensor 17b. The two temperature sensors 17a, 17b serve to detect the input and output temperatures of the water conducted through, these being detected as input values for a controller (not shown) for the heat output of the heating facility 15.

Positioned downstream in the second fluid conduit 9b directly in front of the brewing chamber 23 is a non-return valve 21. It prevents pressure compensation taking place by sucking in air from the brewing chamber if there is a negative pressure in the second fluid conduit 9b. This would bring with it the risk of the second fluid conduit 9b becoming contaminated with brewing residues. Present between the heating facility 15 and the brewing chamber is a valve arrangement 19a, which is used for pressure compensation for the conduit system, consisting of the first fluid conduit 9a and the second fluid conduit 9b. According to the invention the valve arrangement 19a comprises a gas-permeable membrane.

For the purpose of beverage preparation the pump 13 conveys fresh water from the water storage tank 3 into the heating facility 15. It is heated there and fed to the brewing chamber 23. The throughflow meter 11 ensures a precise fill level or dosing of the brewing water and the two temperature sensors 17a, 17b monitor the required temperature for successful preparation of the beverage. At the end of a brewing process the pump 13 deactivates the water feed, while the heating facility 15 continues to run. The water still in the heating facility 15 is quickly converted to steam due to the lack of cool water flowing in behind it and brings about a steam pressure, which pushes the fluid residue downstream of the heating facility 15 in the second fluid conduit 9b through the brewing chamber 23 into a cup 25 provided. The steam pressure also flushes out fluid residue from a beverage capsule in the brewing chamber 23 and dries brewing residues present in the brewing chamber 23. This largely prevents dripping when removing a used beverage capsule or brewing residues, simplifying operation of the hot beverage machine. The residual steam pressure still present in the second fluid conduit 9b after the brewing chamber has been flushed is subsequently relieved by way of the valve arrangement 19a. Because of the membrane in the valve arrangement 19a, this is done successively and without having to overcome a certain pressure difference threshold between the pressure in the second fluid conduit and outside it.

After the end of the beverage preparation process the heating facility 15 is deactivated so that the second fluid conduit 9b downstream of the heating facility 15 cools down. The volume of air and any remaining fluids is reduced, with the result that a negative pressure is produced in the two fluid conduits 9a, 9b. So that the negative pressure does not suck any fluid or substrate residues from the brewing chamber 23 into the fluid conduit 9b and on into the heating facility 15, the non-return valve 21 prevents pressure compensation by way of the brewing chamber 23. It can be configured as an elastic slotted membrane for example. However its function may be impaired by aging or manufacturing tolerances, so that it is no longer totally air-tight. However pressure compensation from the brewing chamber 23 is also prevented by the valve arrangement 19a, as a result of which local pressure compensation also takes place away from the brewing chamber. Therefore if a negative pressure builds up in the second fluid conduit 9b, it is relieved at an early stage by way of the valve arrangement 19a operating as a negative pressure valve.

FIG. 2 shows a second embodiment of the invention, which is in principle almost identical in structure to the one illustrated in FIG. 1 and only differs in the positioning of the valve arrangement. Instead of the valve arrangement 19a in FIG. 1, which was disposed in the second fluid conduit 9b downstream of the heating facility 15, here a valve arrangement 19b of identical structure is positioned upstream of the heating facility 15 in the first fluid conduit 9a.

The positioning of the valve arrangement 19b at this point means that negative pressure is relieved, where otherwise fresh water from the water storage tank 3 would be conveyed in the direction of the heating facility 15 due to the negative pressure. The negative pressure results when the conduit system cools down after a brewing process and steam for example condenses.

Fresh water, which reaches the heating facility due to the negative pressure, would no longer be detected by the throughflow meter 11 during the next brewing process and would pass through the heating facility 15 unheated. The result would then be a thinner and colder beverage, the temperature of which is below the temperature actually desired. Compensation for negative pressure in the region of the fluid conduit 9a however prevents fresh water reaching the fluid conduit 9a so that it does not penetrate as far as the heating facility 15.

Like the valve arrangement 19a in FIG. 1, the valve arrangement 19b comprises a gas-permeable membrane. FIG. 3 shows a sectional representation of a possible layout of a valve arrangement 19, as can be implemented as valve arrangement 19a or 19b for example in the embodiments according to FIGS. 1 and 2.

The valve arrangement 19 (FIG. 3) comprises a cylindrical valve housing 31, consisting of a lower part 35 and an upper part 33, which are connected to one another in a detachable manner. The connection consists of a clip fastening, the elements of which are not shown in the sectional representation. Instead of a clip fastening it is also possible to use a rotational fastening, for example a screw thread or a bayonet fastening. A gas-permeable membrane 39 made of PTFE material with a water-repellent coating is clamped in a peripheral clamping region 41, between the upper part 33 and the lower part 35. The valve arrangement 19 is positioned on a hose 37 of a conduit system in the region of an opening 43 in the hose 37.

If there is a higher pressure in the hose 37 than outside the hose 37, gas passes through the gas-permeable membrane 39 in an outlet direction O, thereby reducing the pressure in the interior of the hose 37. If there is a negative pressure in the hose 37, gas passes through the gas-permeable membrane 39 in an inlet direction I, thereby reducing the negative pressure in the hose 37. Pressure compensation, as desired for example in the embodiments according to FIGS. 1 and 2, is therefore possible in both directions.

The water-repellent coating of the membrane 39 also ensures that water cannot be deposited there for a long period, thereby allowing calcium deposits to be prevented as far as possible. Also the water takes other solid particles with it as it drips off. The pores of the membrane 39 are thereby largely protected from dirt.

The membrane 39 is fastened in a removable manner by clamping between the upper part 33 and the lower part 35, since it is possible to take the upper part 33 off the lower part 35 by opening the clip of the valve arrangement, thereby releasing the membrane 39 for removal. If required the membrane 39 can also be fixed to the upper part 33 and/or lower part 35 by means of an adhesive (not shown here). In such an instance it is also necessary to dissolve the adhesive connection or cut out the membrane 39 in order to remove said membrane 39.

In addition to the membrane 39 the valve arrangement can also comprise a mechanically actuatable valve (not shown here). This ensures for example that pressure compensation is allowed in just one direction and/or only beyond a certain threshold value of the pressure difference inside and outside the hose 37.

Since the valve arrangement described in detail above and the hot beverage machine are exemplary embodiments, they can be extensively modified in the usual manner by the person skilled in the art, without departing from the scope of the invention. In particular the specific embodiment of the fastening mechanism of the valve arrangement or the type of membrane and the arrangement of the valve arrangement within the conduit system can have different forms from those described here. Similarly the hot beverage machine can be embodied in a different form or be provided for different preparation functions. Also the arrangement of individual functional elements in relation to one another within the hot beverage machine can be modified and embodied in many different ways, if this is necessary for space or design reasons. Also the use of the indefinite article “a” or “an” does not rule out the possibility of more than one of the relevant features being present.

### LIST OF REFERENCE CHARACTERS

1 Hot beverage machine
3 Water storage tank
5 Docking valve
7 Cleaning filter
9a First fluid conduit
9b Second fluid conduit
11 Throughflow meter
13 Pump
15 Heating facility
17a First temperature sensor
17b Second temperature sensor
19, 19a, 19b Valve arrangement
21 Non-return valve
23 Brewing chamber
25 Cup
27 Overpressure valve
29 Return conduit
31 Valve housing
33 Upper part
35 Lower part
37 Hose
39 Membrane
41 Clamping region
43 Opening
I Inlet direction
O Outlet direction

1-9. (canceled)

10. A hot beverage machine for household purposes, said hot beverage machine comprising:
a water storage tank;
a heating facility;
a brewing chamber;
a conduit system connecting the water storage tank, the heating facility and the brewing chamber to one another; and
a valve arrangement in a conduit segment of the conduit system, said valve arrangement comprising a gas-permeable membrane.

11. The hot beverage machine of claim 10, wherein the valve arrangement is disposed in a conduit segment of the conduit system between the water storage tank and the heating facility.

12. The hot beverage machine of claim 10, wherein the valve arrangement is disposed in a conduit segment of the conduit system between the heating facility and the brewing chamber.

13. The hot beverage machine of claim 10, wherein the membrane comprises a material made of PTFE.

14. The hot beverage machine of claim 10, wherein the membrane has a water-repellent coating.

15. The hot beverage machine of claim 10, wherein the membrane is removably disposed in the valve arrangement.

16. The hot beverage machine of claim 15, wherein the membrane is clamped in the valve arrangement.

17. The hot beverage machine of claim 10, wherein the valve arrangement comprises a mechanically closing and opening valve.

18. A valve arrangement, comprising a pressure compensation valve disposed in a conduit system of a hot beverage machine between a water storage tank and a brewing chamber and having a gas-permeable membrane.

19. The valve arrangement of claim 18, wherein the membrane comprises a material made of PTFE.

20. The valve arrangement of claim 18, wherein the membrane has a water-repellent coating.

21. The valve arrangement of claim 18, wherein the membrane is removably disposed in the pressure compensation valve.

22. The valve arrangement of claim 21, wherein the membrane is clamped in the pressure compensation valve.
